(19) United States
(12) Patent Application Publication
(10) Pub. No.: US 2001/0044733 A1
(43) Pub. Date: Nov. 22, 2001

(54) Method and system for processing automobile insurance of a prepaid type according to driving distance and time of vehicle

(76) Inventors: Bong - Hyoung Lee, Gangwon-do (KR); Rea - Kyung Soung, Gangwon-do (KR); Ki -Taek Kim, Gangwon-do (KR)

Correspondence Address: William T. Ellis, FOLEY & LARDNER, Washington Harbour, 3000 K Street, N.W., Suite 500, Washington, DC, 20007-5109, US

(21) Appl. No.: 09/741,145

(22) Filed: Dec. 21, 2000

(30) Foreign Application Priority Data
Dec. 23, 1999 (KR) 1999-61038

(51) Int. Cl. G06F 17/60

(52) U.S. Cl. 705/4; 705/41

(57) ABSTRACT

Disclosed are a method and a device for processing an automobile insurance, and more particularly a method and a device for processing an automobile insurance according to a driving distance and time. The method according to the invention includes the steps of purchasing a card, on which a predetermined information on the insurance is recorded, at a price discriminated according to the existing method of calculating an insurance fee, inputting the predetermined information on the insurance recorded on the purchased card to a card reader of the insurance processing system mounted on a vehicle, memorizing the information on the insurance read out by a microcomputer from the card reader in a memory device controlled by the microcomputer, and displaying the same on a display section, inputting driving information sensed by a vehicle driving information sensor connected to the prepaid card-type insurance processing system as the vehicle drives, computing a remaining insurance value or a used insurance value by means of the microcomputer based on the insurance information read out by the card and the driving information inputted by the vehicle driving information sensor, and renewing or extinguishing an insurance value recorded on the card by transmitting the remaining insurance value or the used insurance value computed by the microcomputer to the card reader. The device according to the invention includes a card, on which a predetermined insurance value is recorded, driving sensing means for sensing a driving time or distance of a vehicle, and processing means for reading out insurance information recorded on the card after the card is inserted, displaying a remaining insurance value, calculating a predetermined extinguishing insurance value, subtracting the extinguished insurance value from the remaining insurance value according to a driving time or distance inputted from the driving sensing means, and re-recording the remaining insurance value on the card.

### BACKGROUND OF THE INVENTION

1. Field of the Invention

The present invention relates to a method and a system of processing an automobile insurance, and in particular, a method and a system of processing an automobile insurance according to driving distance and time of a vehicle.

2. Description of the Prior Art

The current automobile insurances are period-based insurances, which compensate for an accident occurred during the period of insurance according to an article of the corresponding insurance once after a vehicle owner pre-pays an insurance fee.

U.S. Pat. No. 5,797,134 (Aug. 8, 1998) discloses a method of calculating an insurance fee by obtaining driving information on a vehicle, while U.S. Pat. No. 5,459,304 (Oct. 17, 1995) and French Application Serial No. 93/05406 (Apr. 30, 1993) disclose a technique of renewing the period of an insurance through communication with the insurance company after elapse of a predetermined period of time by using a card-type insurance card loaded on a vehicle. However, those methods teach a renewal of an insurance through communication with the insurance company upon expiry of the insurance recorded on a card irrespective of a driving distance or a driving time of a vehicle. The calculation of an insurance fee may be made by investigating databasing the information on vehicle law violation, driving distance, driving time, etc. so as to enhance efficiency of determining an insurance fee at the time of subscribing the insurance. However, those methods are nothing more than a manner of extinguishing an insurance fee after elapse of a certain period of time irrespective of a driving time, driving distance or a driving velocity of a vehicle. Therefore, those methods are disadvantageous for the motorists who do not drive the vehicles so frequently or do not violate the vehicle law.

### SUMMARY OF THE INVENTION

It is, therefore, an object of the present invention to provide a method and a system for processing automobile insurance by using a card capable of calculating an insurance fee on a rational basis by considering a driving time, driving distance and a driving velocity of a vehicle once after a driver purchases a debit insurance card effective for a set period of time or distance.

To achieve the above and other objects, there is provided a method for processing an automobile insurance according to a driving time and distance by using a card, comprising the steps of: purchasing a card, on which a predetermined amount of an insurance value is recorded through calculation of the insurance fee at a discriminated price according to the conventional method of calculating an insurance fee; and recording a remaining insurance value and information on a vehicle driving on the card based on the calculated result.

To achieve the above and other objects, there is also provided a device for processing an automobile insurance according to a driving time and distance, comprising: a card recording a predetermined amount of an insurance fee; driving sensing means for sensing a driving time or distance of a vehicle; processing means for reading information on the insurance recorded on the card if the card is inserted thereto to display a remaining insurance value and calculate a predetermined amount of the extinguished insurance value, subtracting the extinguished insurance value from the remaining insurance value according to a driving time or distance inputted from the driving sensing means, and recording the remaining insurance value on the card.

### BRIEF DESCRIPTION OF THE DRAWINGS

The above and other objects, features and advantages of the present invention will become more apparent from the following description when taken in conjunction with the accompanying drawings, in which:

FIG. 1 is a conceptual diagram illustrating a concept of processing an automobile insurance by using a card according to the present invention;

FIG. 2 is a schematic diagram illustrating an insurance processing system mounted on a vehicle according to the present invention;

FIGS. 3A and 3B are views of cards according to embodiments of the present invention;

FIG. 4 is a flow chart illustrating a process of extinguishing an insurance value of a card according to a first embodiment of the present invention;

FIG. 5 is a flow chart illustrating a process of calculating an extinguished insurance value discriminatingly applicable in accordance with a velocity of a vehicle according to the second embodiment of the present invention;

FIG. 6 is a flow chart illustrating a process of extinguishing an insurance value according to a third embodiment of the present invention; and

FIG. 7 is a flow chart illustrating a process of extinguishing an insurance value according to a fourth embodiment of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

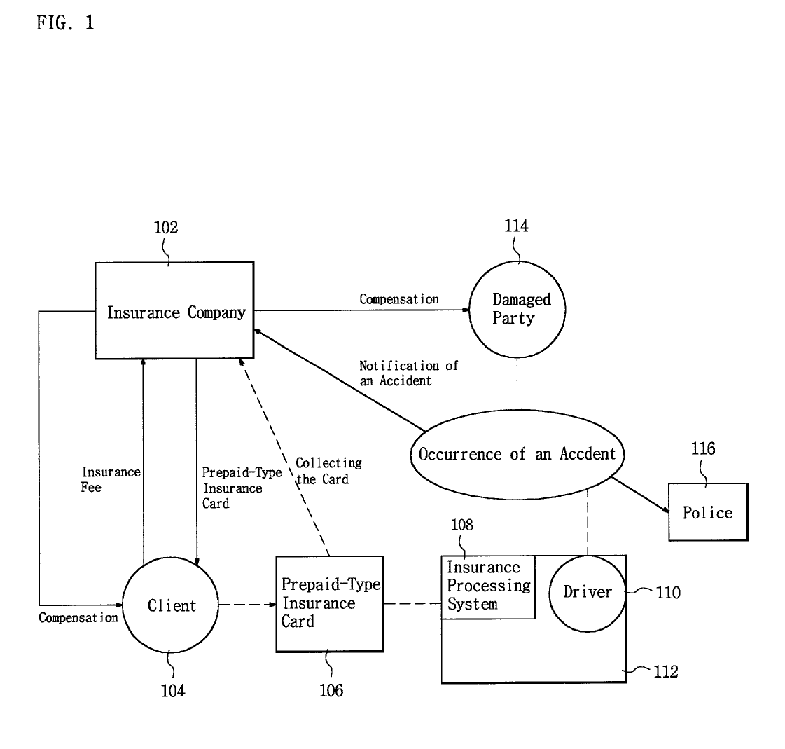

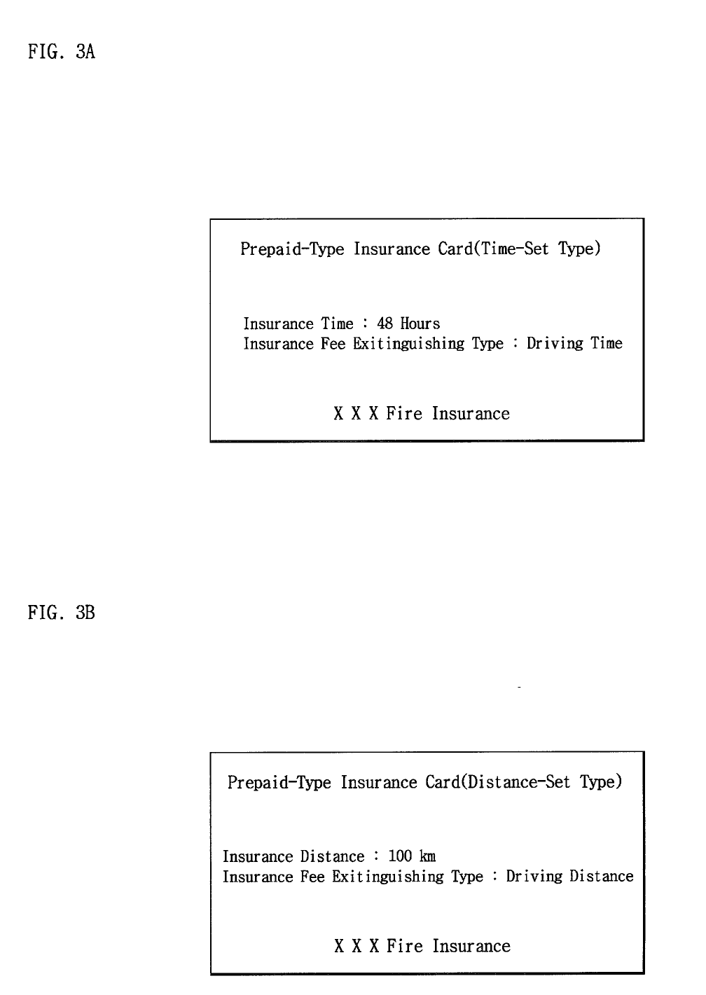

FIG. 1 is a conceptual diagram illustrating a concept of processing an automobile insurance by using a card according to the present invention. According to FIG. 1, a client 104 purchases a card 106 by paying a predetermined amount of an insurance fee to an insurance company 102. The card 106 here may be a prepaid card, credit card, or a transportation card, etc., and may be classified into a time-set type and a distance-set type according to an “insurance value” (i.e., the insuring time or distance), as shown in FIGS. 3A and 3B.

There are two types of extinguishing the insurance value recorded on the card: extinguishing the value according to a driving time; and extinguishing the value according to a driving distance. Even each of these two types can further be classified into two manners: an absolute manner of extinguishing the value by considering either a driving time or a driving distance only; and a conditioned manner of extinguishing the value by considering driving conditions (a driving velocity, etc.) in addition to the driving time or the driving distance. Another available manner is a combined manner of considering both the driving time and distance.

Referring to FIG. 1, an insurance processing device 108 is mounted on a vehicle 112, to which the present invention is applicable. The client 104 purchases the card 106 from the insurance company 112, and inserts the card 106 to the insurance processing device 108 when starting up the vehicle 112. Once the vehicle l12 is driven, the card 106 senses the insured time or distance depending on a driving time or distance according to the present invention. If a traffic accident occurs in the course of driving, a driver reports the accident to a police 116 and to the insurance company 102. The insurance company then collects the card 106 to read the driving information and determine validity of the card so as to compensate for an insurance amount to the injured and the insurance subscriber (client) according to the insurance article.

Thus, the insurance fee can be settled on a rational basis because the insurance value is extinguished depending on the driving time or distance and only when the vehicle 112 is on a driving status.

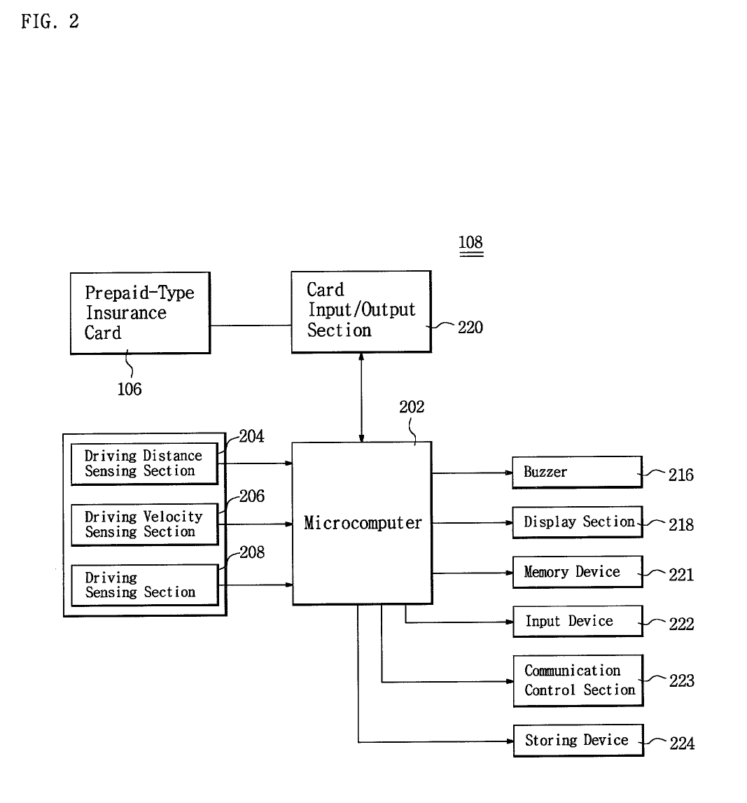

FIG. 2 is a schematic diagram illustrating an insurance processing system mounted on a vehicle according to the present invention. FIG. 2 shows that an insurance processing system 108 comprises a microprocessor(202), a driving distance sensing section 204, a driving velocity sensing section 206, a driving sensing section 208, a buzzer 216, a display section 218, a card input/output section 220, a memory device 221, an input device 222, and a communication control section 223.

Referring to FIG. 2, the debit insurance card (hereinafter, referred to as a “card”) 106 records information related to calculation of an insurance value including an insurance fee calculating formula of an insurance value rate according to a driving time or a driving distance, a type of an insurance such as an amount-set type, a time-set type or a distance-set type, and personal information of the insurance subscriber, etc. The card 106 can record or delete such information on a recording section comprising a semiconductor chip including a flash memory, etc. or a magnetic tape.

If the driver 110 of a vehicle having a prepaid card-type insurance processing system inputs a start-up key to the vehicle for start-up, the microprocessor 202 of the prepaid card-type insurance processing system determines whether or not the card has been inserted to the card input/output section 220 of the card reader, which can read or record the information on the card 106.

In the negative, the microprocessor 202 either transmits characters requiring an insertion of the card 106 to the display section 218 or generates a buzzer sound through the buzzer 216.

Though not shown in the drawings, an additional function may be annexed to the prepaid-type insurance processing system so as to cease the start-up of the vehicle by transmitting a driving cessation signal to a vehicle driving control device (a start-up key control section, etc.).

In the affirmative, the microprocessor 202 displays an amount of insurance value according to the drivable time and distance among the data read by the card reader.

The microprocessor 202 records the information on the insurance fee rate calculation formula and the data on a type of the insurance inputted from the card 106 on the memory device 221 such as RAM, etc. housed in the microprocessor 202. Also, in consideration of a recording capacity of the card 106, the insurance value may be calculated by using the memory device 221 comprising a fixed semiconductor chip such as ROM, etc. in the microprocessor 202 to record the information on the insurance fee rate calculation depending on the type of insurance.

If the vehicle starts driving, driving information is inputted to the microprocessor 202 from the driving distance sensing section 204, driving velocity sensing section 206, driving sensing section 208, etc.

A generic device may be utilized as the device of sensing the driving information to extract data required for the present invention. A tachometer, commercialized as a driving recorder, may be utilized if necessary.

The microprocessor 202 computes information related to the insurance recorded in the memory device 221 of the microprocessor and the driving information to calculate a remaining insurance value or a used insurance value (hereinafter, referred to as a “remaining insurance value”). The calculated result is stored in a storing device 224 comprising a RAM, a rewritable CD, a magnetic recording tape, etc., which are controlled by the microprocessor 202. The data stored in the storing device 224 are periodically (in a minute unit or a km unit) transmitted to the card reader by the microprocessor 202 so as to extinguish the remaining insurance value of the card for renewal of the insurance value. If a driving cessation signal is inputted from the driving information sensing section, the microprocessor 202 transmits the final data of the storing device 224 to the card reader so as to extinguish the used amount from the remaining insurance value for renewal of the remaining insurance value.

In case the extinction is simply an insurance fee extinction performed according to a driving time or distance based on the agreement between the insurance company and the driver, information on time and distance, personal information, a type of the insurance, etc. are recorded on the card except the information on the insurance fee rate calculation. Thus, it is obvious to those skilled in the art that the microprocessor 202 needs not perform computation for an insurance fee calculation. What also belongs to the category of the present invention are that the microprocessor 202 receives the driving information during driving from the driving sensing devices without the storing device 224 controlled by the microprocessor 202, and transmits the received information to the card reader in real time for renewal of the insurance value recorded on the card.

The microprocessor 202 stores the data inputted from the driving information sensing devices in the storing device 224, and may periodically delete the stored data considering the capacity of the storing device 224, etc. The microprocessor 202 may also transmit the stored data to the card reader and record the driving information on the card so as to grasp the driving status before an accident, if occurred, and utilize the recorded information as a statistical material for calculating insurance fees.

The driver accesses the insurance company via telephone or a public communication network such as data communication network through internet by utilizing a wire or wireless telecommunication network connected to the communication control section 223, which is controlled by the microprocessor 202 when an additional subscription is determined to be required by reference to the remaining insuring distance and time as well as to the remaining insurance value. Thereafter, personal information including the ID, the password set at the time of subscribing the insurance is transmitted by the input device 222 or by means of a vocal communication so that the microprocessor 202 can receive the required insurance value including the insuring distance and time via a wire or wireless public communication network and the communication control section 223. The microprocessor 202 transmits the received information to the card reader to renew the remaining insurance value recorded on the card.

It is obvious to those skilled in the art that the driver may renew the information related to the insurance recorded on the card by means of a card charger installed at affiliated shops designated by the insurance company.

FIG. 3A is an exemplary card of a time-set type according to the present invention that may be classified into a 12-hour card, a 24-hour card, a 48-hour card, a three-day card, a week card, a month card, a three-month card, etc. according to an insuring time. FIG. 3B is an exemplary card of a distance-set type card according to the present invention that may be classified into a 100 km card, a 500 km card, a 1000 km card, a 10,000 km card, a 30,000 km card, etc. according to an insuring distance. Such cards can be realized by IC cards or magnetic cards, on which the insuring time/distance, the insurance company, user's manual may be printed. Electro-magnetically, the cards may record the data such as the card number, the code of a card type, the code of the insurance company, the remaining distance/time, the extinguished time/distance, the driving information, the time of accident, etc. according to a predetermined format.

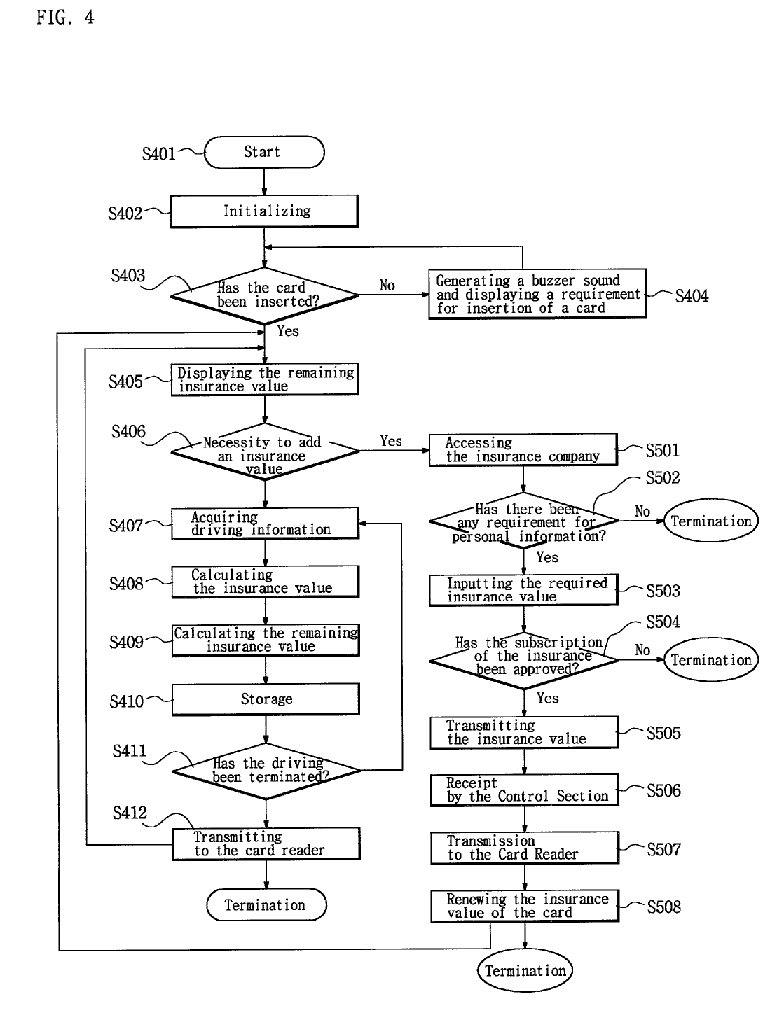

FIG. 4 is a flow chart illustrating a process of extinguishing an insurance value of a card according to a first embodiment of the present invention. The client (104 in FIG. 1) purchases a card from the insurance company 102 at a price discriminated according to the conventional insurance fee calculating method. The client 104 then inserts the card to the debit-type insurance processing device 108 mounted on a vehicle when starting up the vehicle.

If the start-up key is inserted to the vehicle for driving, a power supply is applied to the insurance processing system 108 of the present invention (S401). Subsequently, the microprocessor 202 operates to initialize diverse parameter values (S402). It is then determined whether or not the card 106 has been inserted (S403). In the negative, a buzzer 216 is sounded or characters are displayed such that “Insert the card” on the display section 218 to require insertion of the card (S404).

In the affirmative, the card input/output section 220 reads the information recorded on the card (S405). The information recorded on the card includes a type of the card (a time-set type or a distance-set type, etc.) and an insurance value such as the remaining insurance time/distance, etc. The read-in insurance value is displayed on the display section 218 comprising an LCD. The information on the insurance fee rate calculation recorded on the card is recorded in a RAM, which is a memory device 221 of the microprocessor 202. In case that the insurance fee rate calculation formula is pre-set in a ROM of the microprocessor 202, the ROM is activated.

The vehicle is driven if the insurance value displayed on the display section 218 is “0” or if no necessity to add the insurance value (or to renew the insurance) is determined by the driver (S406).

In case that the remaining insurance value is “0”, the microprocessor 202 either sounds the buzzer 216 for warning or displays a warning phrase such as “No insurance applicable” on the display section 218.

In case that a necessity to add the insurance value is determined, the driver accesses the insurance company via a wire or wireless telecommunication network or a data communication network to perform a process of adding the insurance value (S501) as will be described later.

As the vehicle is driven, the vehicle driving information is inputted to the microprocessor 202 from the driving information sensing devices such as the driving distance sensing section 204, the driving velocity sensing section 206, etc. (S407).

The microprocessor 202 calculates the used insurance value based on the inputted driving information and the type of insurance inputted from the card or the insurance fee rate calculating formula already inputted to the microprocessor 202 (S408). The microprocessor 202 then calculates the used insurance vale based on the remaining insurance value inputted from the card (S409), and stores the used insurance value in the storing device 224 (S410). The microprocessor 202 then determines whether or not the driving has been terminated by reference to the driving information inputted from the driving information sensing devices (S411). If the driving is determined to have been terminated, the remaining insurance value recorded in the storing device 224 is transmitted to the card reader so as to renew the remaining insurance value recorded in the card (S412) and to terminate the process.

The storing section for storing the result calculated in the insurance fee calculating step may record the driving information obtained in the driving information obtaining step as well. If necessary, the microprocessor 202 may periodically read out the driving information record from the storing device 224 or the card either after termination of the driving or during the driving by recording the driving information in the card.

At this stage, the insurance fee is calculated in the calculation step (S408) of the used insurance value according to the construction of the system of the present invention. It is obvious that present invention includes the process of calculating the used insurance value only without calculating the difference between the insurance fee and the remaining insurance value and stored in the calculating step (S409) of the remaining insurance value, as well as the process of reading out the stored used insurance value with the card reader so as to delete the read-out value from the remaining insurance value recorded in the card upon termination of the driving.

It is also obvious that the present invention includes a possibility of omitting the step of storing in the storing device 224 if the system is constructed to calculate the remaining insurance value and the used insurance value in real time and to extinguish the remaining insurance value recorded on the card according to the present invention.

If the driver determines a necessity to add an insurance value in step 406 of determining whether or not to add the insurance value, the driver communicates with the insurance company via a wire or wireless telecommunication network or a data communication network so as to add the insurance value or renew the insurance via the communication control section 223 controlled by the microprocessor 202.

According to the an embodiment of the present invention, the communication control section 223 controlled by the microprocessor 202 for adding the insurance value or renewing the insurance is preferably a wire or wireless modem or the one that can be combined with a wire or wireless telecommunication terminal. The microprocessor 202 accesses the server of the insurance company by using a wire or wireless terminal connected to the communication control section 223 by operating a communication software such as a web browser for internet connection, e.g., an Internet Explorer of Microsoft Corporation (S501). The server of the insurance company requires personal information and a password of the driver given at the time of the subscribing the insurance. The driver inputs the above requisites by means of the input device 222 controlled by the microprocessor 202. The server of the insurance company then identifies the driver (S502). Once the driver is identified to be an insurance subscriber, the server of the insurance company receives a window for inputting the insurance value and the data related to a settlement of the insurance fee including the credit card number, the bank account number, etc. of the driver (S503) to determine whether or not to approve addition of the insurance value (S504). When approved, the added value of the insurance fee as requested by the driver is transmitted to the microprocessor 202 of the driver's vehicle. The microprocessor 202 receives and displays the transmitted value on the display section 218 (S507), while transmitting the same to the card reader (S508) to renew the remaining insurance value recorded on the card.

The insurance value can be renewed by the card alone, according to the present invention, when used in a shop installing an insurance value renewing device connected to an insurance company for the purpose of renewing the insurance value such as an addition or a renewal of the insurance.

An operation of the card value renewing terminal may be realized with the technology well-known in the recycling field of recharging the card when no value remains as a result of reducing the value according to the data recorded on the card.

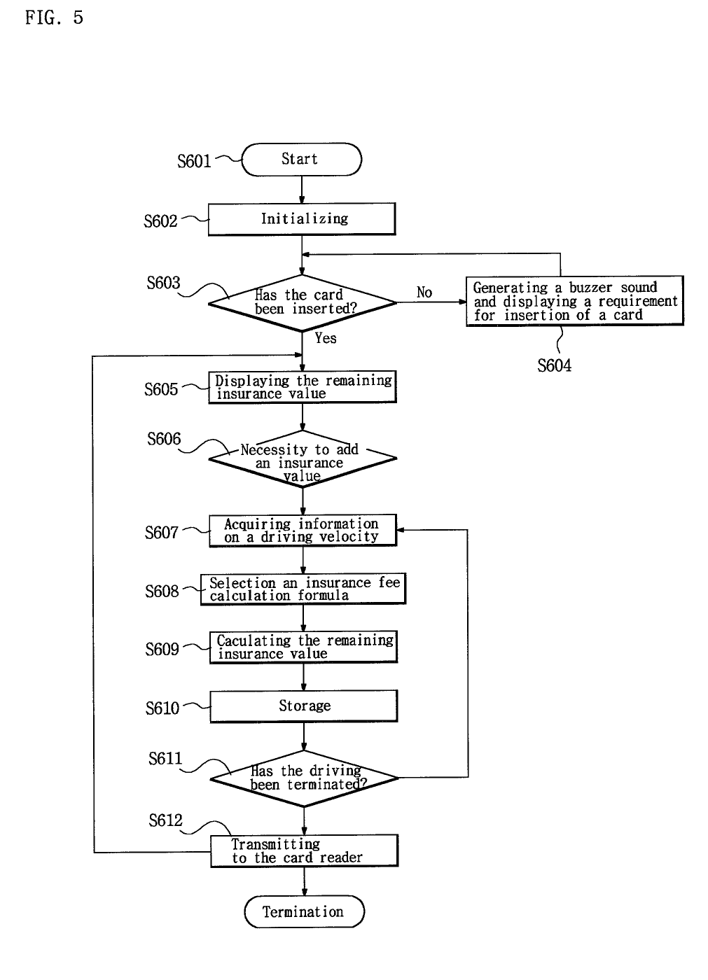

FIG. 5 is a flow chart illustrating a process of calculating an extinguished insurance value discriminatingly applicable in accordance with a velocity of a vehicle according to another embodiment (hereinafter, referred to as “a second embodiment”) of the present invention. FIG. 5 shows the same process as FIG. 4 as long as the step of obtaining the driving information, while illustrating the step of calculating the insurance fee in detail. Therefore, steps 601, 602, 603, 604, 605, and 606 are performed to be the same as the steps 401, 402, 403, 404, 405, and 406 in FIG. 4 illustrating a flow according to the first embodiment of the present invention.

As shown in FIG. 5, the microprocessor 202 receives information on a driving velocity from the driving information device of the vehicle (S607), and selects the calculation formula received from the card or pre-inputted and memorized in the memory device 221 of the microprocessor 202 (S608). The selected calculation formula is a formula for calculating an insurance value by discriminatingly applying the insurance fee applicable rates according to driving velocities as shown in Table 1 below.

The microprocessor 202 detects data on velocity from the data in the driving information sensing section, and calculates the driving velocity by using the selected calculation formula to calculate the remaining insurance value (step 609). The microprocessor 202 then determines whether or not the driving has been terminated by reference to the driving information inputted from the driving information sensing devices (S611). If the driving is determined to have been terminated, the remaining insurance value recorded in the storing device 224 is transmitted to the card reader so as to renew the remaining insurance value recorded in the card (S612) and to terminate the process.

TABLE 1

| Driving Velocity | Premium Rate |
|---|---|
| Up to 120 km/h | 1 |
| 120-140 km/h | 1.2 |
| Higher than 140 km/h | 1.4 |

As shown in the above Table 1, the unit extinguishing insurance value is applied to actually extinguishing the insurance value when the driving velocity is below 120 km/h, whereas the value multiplying the unit extinguishing insurance value by 1.2 is applied to actually extinguishing the insurance value when the driving velocity is 120 km/h-140 km/h. When the driving velocity is higher than 140 km/h, the value multiplying the unit extinguishing insurance value by 1.4 is applied to actually extinguishing the insurance value. Such values in Table 1 are merely examples, and further detailed classification may be made in actual extinction of the insurance value according to the driving velocities.

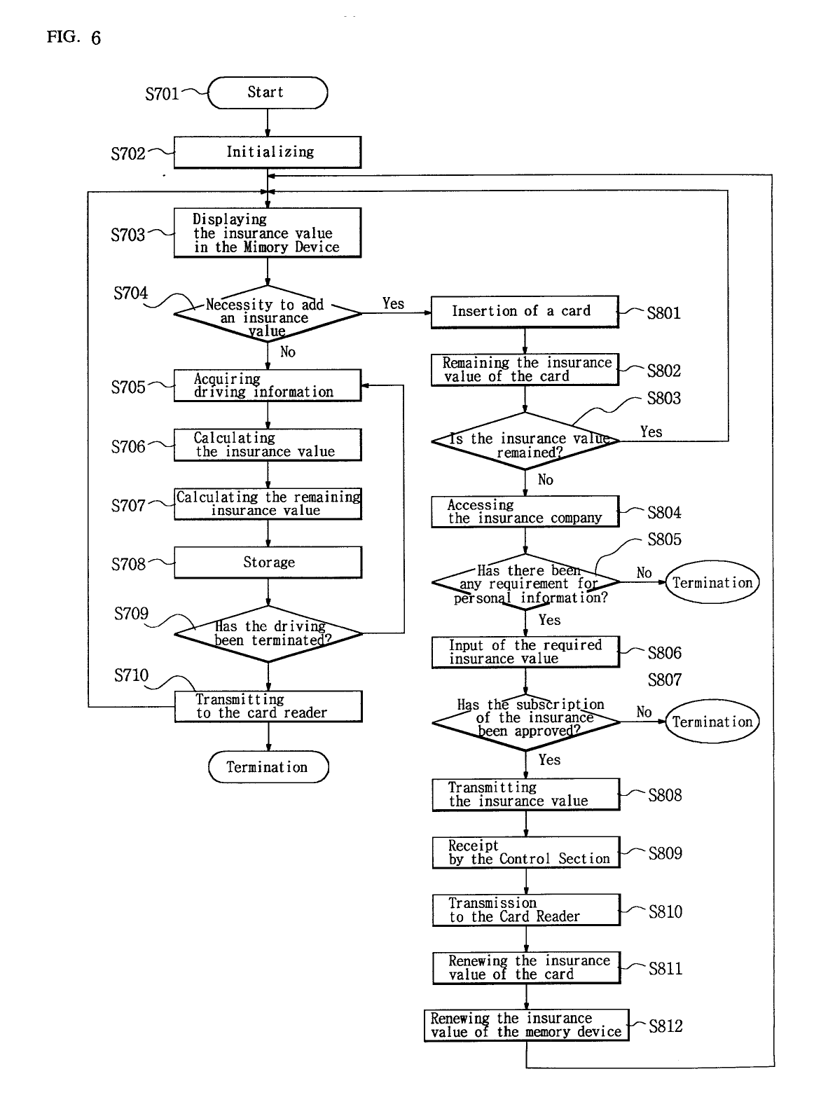

FIG. 6 is a flow chart illustrating a process of extinguishing an insurance value according to another embodiment (hereinafter, referred to as a “third embodiment”) of the present invention. After purchasing a card, the driver inserts the card to the card reader mounted in a vehicle. The microprocessor 202 then reads in the information related to the insurance including the insurance value, etc., and memorizes the same I the memory device 221. The memory device 221 used here is preferably an EEPROM or an element having an equal or a higher function, which can always memorize the recorded information irrespective of the switch-on or off of the power supply and can easily delete or modify the memorized record, if necessary.

Thus, once the driver inputs the card only once after its purchase in the initial driving through a card reader, the debit-type insurance processing system allows driving of a vehicle subscribing an insurance without additional insertions of the card thereafter.

FIG. 6 illustrates the insurance processing steps only after the insurance information on the card has been inputted through the card reader according to the third embodiment of the present invention. Once a vehicle key is inputted by the driver for driving of the vehicle (S701), the insurance processing system initializes all the device (S702). The microprocessor 202 then reads out the information recorded in the memory device 221, which has received and is storing the insurance information including the insurance value recorded on the card, and displays the remaining insurance value on the display section 218 (S703).

The vehicle is driven if the insurance value displayed on the display section 218 is “0”, or no necessity to add the insurance value (or to renew the insurance) is determined by the driver (S704).

In case that the remaining insurance value is “0”, the microprocessor 202 either sounds the buzzer 216 for warning, or displays a warning phrase such as “No insurance applicable” on the display section.

In case that a necessity to add the insurance value is determined, the driver accesses the insurance company via a wire or wireless telecommunication network or a data communication network to perform a process of adding the insurance value as will be described later (S801).

The microprocessor 202 performs a series of steps 705, 706, 707, 708 and 709 including an acquisition of driving information shown in FIG. 6 to be the same as the steps 407, 408, 409, 410 and 411 in FIG. 4 illustrating a flow according to the first embodiment of the present invention. The microprocessor 202 renews the remaining insurance value recorded in the memory device by transmitting the remaining insurance value or the used insurance value to the memory device upon termination of the driving (S710).

Also, as in case of the first embodiment, the microprocessor 202 inserts the card to the card reader if a necessity to renew (recharge) the insurance value stored in the memory device 221 (S801). The microprocessor 202 then reads out the insurance information recorded on the card to determine whether or not the read-out insurance information accords with the initially inputted insurance information (S802). The microprocessor 202 subsequently displays the insurance value of the card on the display section. If any remaining insurance value exists, the microprocessor 202 transmits the remaining insurance value to the memory device to renew the insurance value of the memory device (S803). If no remaining insurance value exists, the driver performs a step of receiving an insurance value on the card by accessing the insurance company. FIG. 6 illustrates these steps to be steps 804 to 811, which are identical to the steps 501 to 508 in FIG. 4 illustrating the first embodiment of the present invention. Thus, the detailed description on the steps 804 to 811 will be omitted here. Upon renewal of the insurance value of the card (S811), the microprocessor 202 reads out the insurance value of the card to renew the insurance value in the memory device (S812).

As in case of the first embodiment, the third embodiment of the present invention is capable of storing the driving information in the storing device 224 together with the remaining insurance value. Further, the insurance value calculation result can be transmitted to the memory device 221 in real time to renew the insurance value in the memory device.

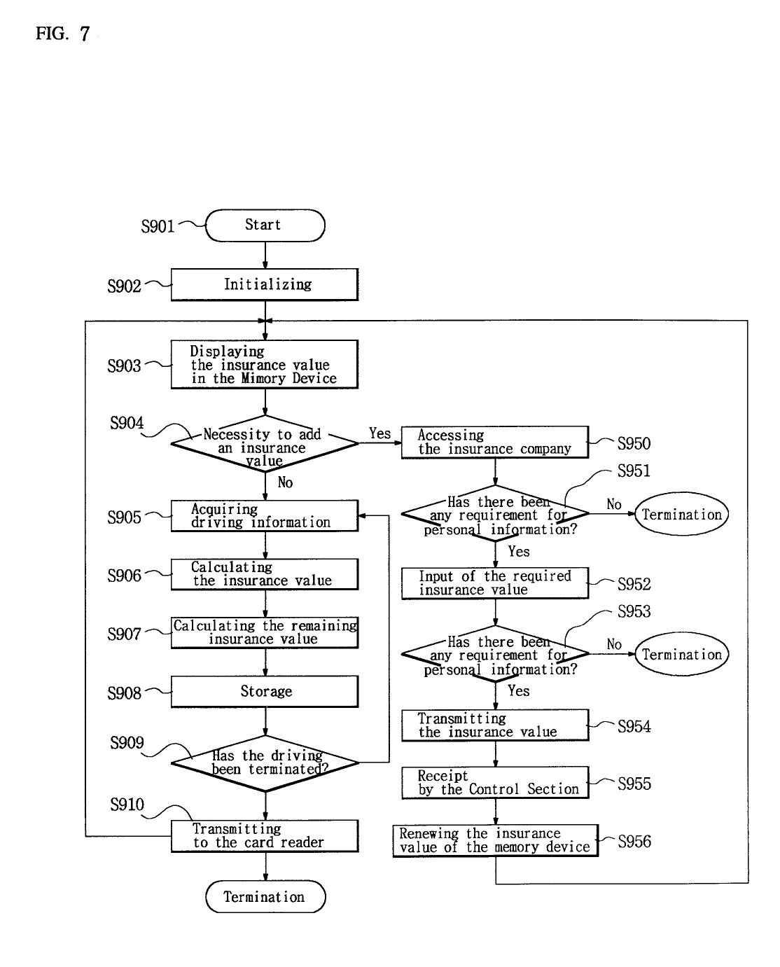

FIG. 7 is a flow chart illustrating a process of directly inputting the insurance fee agreed between the driver and the insurance company in the memory device of the prepaid-type insurance processing system mounted on a vehicle via a communication network without relying on the card according to another embodiment (hereinafter, referred to as a “fourth embodiment”) of the present invention. The prepaid-type insurance processing system according to the fourth embodiment is first installed in a vehicle upon agreement between the driver and the insurance company. Diver information related to the insurance as well as the insurance value are inputted in the memory device 221 of the system. When the insurance value has been extinguished, the driver accesses the server of the insurance company The server of the insurance company then identifies the subscriber by reference to the password registered at the time of subscription. The driver subsequently becomes able to recharge the insurance value from the insurance company via a wire or wireless telecommunication network.

The microprocessor 202 receiving the insurance value through the wire or wireless telecommunication network stores the insurance value in the memory device 221. The memory device 221 used here is preferably an EEPROM or an element having an equal or a higher function, which can always memorize the recorded information irrespective of the switch-on or off of the power supply and can easily delete or modify the memorized record, if necessary.

A password is required for mutual authentication in transmitting and receiving the insurance value between the insurance company and the driver. The encoding method used here is preferably a public key method, which is a well-known technology in the encoding field. If necessary, a private key method may be selected or an encoding program developed by the insurance company may be utilized.

The driver thus can receive the insurance value when installing the system of the present invention, and remotely recharge the insurance value while in use via a wire or wireless telecommunication network, if necessary. Therefore, it is possible to drive the vehicle insured to pay an insurance fee according to use of the vehicle.

The following is a detailed description of the processing steps according to the fourth embodiment of the present invention. Referring to FIG. 7, the driver and the insurance company concludes an agreement on insuring conditions. The insurance company installs the prepaid-type insurance processing system in the driver's vehicle, to which the present invention is applicable. The insurance company then inputs information related to the insurance including the insurance value in the memory device 221.

The subsequent steps are identical to steps 701 through 710 as shown in FIG. 6 illustrating the third embodiment of the present invention.

To be specific, once the driver inserts a key for start-up of a vehicle, the insurance processing system initializes all the devices (step 902). Microprocessor 202 reads out the information recorded in the memory device 221, and displays the remaining insurance value on the display section 218 (step 903).

The vehicle is driven, if the insurance value displayed on the display section 218 is “0”, or if no necessity to add (or renew) the insurance fee is determined by the driver (step 904).

In case that the remaining insurance value is “0”, the microprocessor 202 either sounds the buzzer 216 for warning or displays a warning phrase such as “no insurance applicable” on the display section.

In case that a necessity to add the insurance value is determined, the driver performs a process of adding the insurance value by accessing the insurance company via wire or wireless telecommunication network or a data communication network, as will be described later (step 950).

The microprocessor 202 subsequently performs steps 905 through 909 in FIG. 7 to be identical to steps 407 through 411 in FIG. 4. Upon termination of the driving, the remaining insurance value or the used insurance value is transmitted to the memory device 221 (step 910) to renew the remaining insurance value recorded in the memory device.

If a necessity to renew (recharge) the insurance value stored in the memory device 221 is determined as in case of the first embodiment, the driver performs a process of receiving the insurance value by accessing the insurance company as illustrated in steps 950 through 956 in FIG. 7, the description of which is omitted here due to identity to steps 501 through 506 in FIG. 4. The microprocessor 202 receives the insurance value received by the communication control section, and renew the insurance value in the memory device 221 (step 956).

According to the fourth embodiment of the present invention, the driving information can be stored in the storing device 224 together with the remaining insurance value, as in case of the first embodiment. Also, the insurance value may be renewed by transmitting the calculated insurance value to the memory device 221 in real time.

The following is a description of another embodiment (hereinafter, referred to as a “fifth embodiment”; no flow chart is shown in the drawings) of the present invention. According to the fifth embodiment, the driving information is inputted from a driving information sensor attached to a vehicle to calculate the remaining insurance value in the first through the fourth embodiments of the present invention, and is recorded in the card 106, a storing device 224 or in the memory device 221. The stored driving information and the remaining insurance value are periodically (e.g., once every month) read out by the microprocessor 202 and transmitted to the server of the insurance company via a wire or wireless telecommunication terminal. Otherwise, the driver may transmit the stored driving information and the remaining insurance value to the server of the insurance company through an access thereto on an irregular basis. Also, when the remaining insurance value has a predetermined value (e.g., below 10% of the subscribed insurance value), the microprocessor 202 recognizes the value, and transmits the driving information and the remaining insurance value to the server of the insurance company The server of the insurance company transmits a phrase, etc. requiring a renewal of the insurance value on the display section 218 of the insurance processing device of the present invention.

When the server of the insurance company requires the recorded information through communication between the microprocessor 202 and the server of the insurance company, the microprocessor 202 reads out and transmits the pertinent information to the server of the insurance company.

The server of the insurance company may make the information as a database related to an insurance subscription. The server of the insurance company transmits the remaining insurance value and record of use, etc. to the driver based on the information via E-mail, an internet terminal, or the display section 218 of the insurance processing device of the present invention.

As described above, the present invention realizes a rational automobile insurance system by paying an insurance fee according to an actual driving time or distance rather than according to a period of insurance. Since the insurance fee is paid depending on the driving of a vehicle, the practice of unnecessary driving can be particularly avoided by utilizing present invention, thereby contributing to the energy policy and the transportation policy as well as to an environment in reducing the pollution. Further, driving with excessive speed can be prevented and traffic accidents can be reduced by discriminatingly imposing the insurance fee according to driving velocities. Moreover, purchasing and recharging the card for paying the insurance fee also serve for saving the expenses and user convenience.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for processing an insurance of a prepaid type, comprising the steps of:
purchasing a card, on which a predetermined information on the insurance is recorded, at a price discriminated according to the existing method of calculating an insurance fee;
inputting the predetermined information on the insurance recorded on the purchased card through a card reader of a prepaid-type insurance processing system mounted on a vehicle;
memorizing the information on the insurance read out by a microcomputer from the card reader in a memory device controlled by the microcomputer, and displaying the same on a display section;
inputting driving information sensed by a vehicle driving information sensor connected to the prepaid-type insurance processing system as the vehicle drives;
computing a remaining insurance value or a used insurance value by means of the microcomputer based on the insurance information read out by the card and the driving information inputted by the vehicle driving information sensor; and
renewing or extinguishing an insurance value recorded on the card by transmitting the remaining insurance value or the used insurance value computed by the microcomputer to the card reader.

2. The method of claim 1, wherein the insurance information recorded on the card is the original information of the vehicle including a type of the insurance, an insurance fee rate calculation formula according to the type of the insurance, an insurance value, personal information on the insurance subscriber, and a manufactured year of the vehicle, and a kind of the vehicle.

3. The method of claim 2, wherein the insurance value is a driving distance or a driving time of the vehicle.

4. The method of claim 1, further comprising the steps of: before displaying the insurance information read out from the card,
determining whether or not the card has been inserted to a card inserting outlet of the card reader; and
displaying a warning phrase requiring an insertion of the card, if not inserted, on the display section controlled by the microcomputer, or sounding a buzzer controlled by the microcomputer.

5. The method of claim 1, further comprising the steps of: when adding the insurance value displayed on the display section controlled by the microcomputer or when renewing the insurance,
accessing a server of the insurance company by means of a communication control section controlled by the microcomputer, a wire or wireless telecommunication terminal, and an input device connected to the communication control section;
inputting information on a driver including personal information and information related on the insurance including a required amount of the insurance fee, a type of the insurance, a bank account to settle the insurance fee to the accessed server of the insurance company;
approving the requisites of the driver by the server of the insurance company;
transmitting the approved insurance value to the prepaid-type insurance processing system of the driver; and
transmitting the received insurance value to the card reader and renewing (recharging) the insurance value of the card by the microcomputer, which has received the transmitted insurance value.

6. The method of claim 1, further comprising the steps of: after computing the remaining insurance value or the used insurance value by the microcomputer,
storing the computed result to a storing device controlled by the microcomputer; and
transmitting the remaining insurance value or the used insurance value stored in the storing device to the card reader at regular intervals or upon termination of the driving, and renewing the insurance value recorded on the card.

7. The method of claim 6, characterized by storing the computed result together with the driving information in the storing device controlled by the microcomputer.

8. The method of claim 7, further comprising the steps of:
reading out the computed result and the driving information stored in the storing device by the microcomputer at regular or irregular intervals or upon request from the server of the insurance company;
transmitting the read-out information to the server of the insurance company via a the wire or wireless terminal connected to the communication control section controlled by the microcomputer; and
databasing the computed result and the driving information inputted to the server of the insurance company.

9. The method of claim 8, further comprising the step of processing the databased information and transmitting the same to the driver via correspondence, E-mail, and an internet terminal at regular intervals or when the remaining insurance value is less than a predetermined value.

10. The method of claim 1, wherein the card is capable of reading out, re-recording or extinguishing the information recorded thereon by using a terminal installed by the insurance company.

11. The method of claim 1, wherein the step of calculating the remaining insurance value or the used insurance value is computing the remaining insurance value or the used insurance value at a discount or a premium according to driving velocity.

12. A method for processing an insurance of a prepaid type, comprising the steps of:
purchasing a card, on which a predetermined information on insurance is recorded, at a price discriminated according to the existing method of calculating an insurance fee;
inputting the predetermined information on the insurance recorded on the purchased card through a card reader of the insurance processing system mounted on a vehicle;
memorizing the information on the insurance read out by a microcomputer from the card reader in a memory device controlled by the microcomputer, and displaying the same on a display section;
inputting driving information sensed by a vehicle driving information sensor connected to the prepaid-type insurance processing system as the vehicle drives;
computing a remaining insurance value or a used insurance value by means of the microcomputer based on the insurance information read out by the card and the driving information inputted by the vehicle driving information sensor; and
transmitting the remaining insurance value or the used insurance value computed by the microcomputer to the memory device so as to renew or extinguish the insurance value recorded in the memory device.

13. The method of claim 12, further comprising the steps of: when adding the insurance value displayed on the display section controlled by the microcomputer or when renewing the insurance,
inserting the card to an input/output section of the card reader by a driver;
reading out the insurance information including the insurance value recorded on the card, displaying the insurance value on the display section, and renewing the remaining insurance value in the memory device, if any remaining insurance value exists, by the microcomputer;
accessing a server of the insurance company by means of a communication control section controlled by the microcomputer, a wire or wireless telecommunication terminal and an input device connected to the communication control section if no remaining insurance value exists.
inputting information on the driver including personal information and the information related to the insurance including the required amount insurance fee, a type of the insurance, a bank account to settle the insurance fee to the accessed server of the insurance company;
approving the requisites of the driver by the server of the insurance company;
transmitting the approved insurance value to the prepaid-type insurance processing system of the driver; and
transmitting the received insurance value to the card reader and renewing (recharging) the insurance value of the card by the microcomputer, which has received the transmitted insurance value.

14. The method of claim 12, further comprising the steps of: when adding the insurance value displayed on the display section controlled by the microcomputer or when renewing the insurance,
inserting the card to an input/output section of the card reader by a driver;
reading out the insurance information including the insurance value recorded on the card, displaying the insurance value on the display section, and renewing the remaining insurance value in the memory device, if any remaining insurance value exists, by the microcomputer;
accessing a server of the insurance company by means of a communication control section controlled by the microcomputer, a wire or wireless telecommunication terminal, and an input device connected to the communication control section if no remaining insurance value exists.
inputting information on the driver including personal information and the information related to the insurance including the required amount insurance fee, a type of the insurance, a bank account to settle the insurance fee to the accessed server of the insurance company;
approving the requisites of the driver by the server of the insurance company; transmitting the approved insurance value to the prepaid-type insurance processing system of the driver; and
transmitting the received insurance value to the card reader and renewing the insurance value of the card by the microcomputer, which has received the transmitted insurance value.

15. The method of claim 12, further comprising the steps of: after computing the remaining insurance value or the used insurance value,
storing the computed result in the storing device controlled by the microcomputer; and
transmitting the remaining insurance value or the used insurance value stored in the storing device to the memory device at regular intervals or upon termination of the driving, and renewing the remaining insurance value recorded in the memory device.

16. The method of claim 12, characterized by storing the computed result together with the driving information in the storing device controlled by the microcomputer.

17. The method of claim 16, further comprising the steps of:
reading out the computed result and the driving information stored in the storing device by the microcomputer at regular or irregular intervals or upon request from the server of the insurance company;
transmitting the read-out information to the server of the insurance company via a wire or wireless terminal connected to the communication control section controlled by the microcomputer; and
databasing the computed result and the driving information inputted to the server of the insurance company.

18. The method of claim 8 or 17, further comprising the step of processing the databased information and transmitting the same to the driver via correspondence, E-mail, an internet terminal at regular intervals or when the remaining insurance value is less than a predetermined value by the server of the insurance company.

19. A method for processing an insurance of a prepaid type, comprising the steps of:
inputting a predetermined information on insurance at a price discriminated according to the conventional method of calculating an insurance fee to a memory device of a prepaid-type insurance processing system;
reading in an insurance value memorized in the memory device, and displaying the read-in the insurance value on a display section by a microcomputer of the prepaid-type insurance processing system;
inputting information on driving to the microcomputer by a driving information sensor connected to the prepaid-type insurance processing system according to driving of a vehicle;
computing a remaining insurance value or a used insurance value based on the information on driving read-in by the memory device and the information on driving inputted from the driving information sensor by the microcomputer; and
renewing or extinguishing the insurance value recorded in the memory device by transmitting the remaining insurance value or the used insurance value computed by the microcomputer.

20. The method of claim 19, further comprising the steps of: when adding the insurance value displayed on the display section controlled by the microcomputer or when renewing the insurance,
accessing a server of the insurance company by means of a communication control section controlled by the microcomputer, a wire or wireless telecommunication terminal, and an input device connected to the communication control section;
inputting information on a driver including personal information and information related on the insurance including a required amount of the insurance fee, a type of the insurance, a bank account to settle the insurance fee to the accessed server of the insurance company;
approving the requisites of the driver by the server of the insurance company;
transmitting the approved insurance value to the prepaid-type insurance processing system of the driver; and
transmitting the received insurance value to the memory device and renewing (recharging) the insurance value of the memory device by the microcomputer, which has received the transmitted insurance value.

21. A system for processing an insurance of a prepaid type, comprising:
memory means for memorizing information on insurance of a prepaid type including a type of insurance, subscribed insurance value, personal information on a driver, diverse information on a vehicle;
read-out means for reading out information on the insurance including the insurance value stored in the memory means;
recording means for recording information on the insurance on the memory means;
display means for displaying information stored in the memory means;
driving information sensing means for sensing driving information of the vehicle;
storing means for storing the driving information and a result computed by computing means;
communication control means for communicating the information stored in the memory means and the storing means with an insurance company via a wire or wireless telecommunication network; and
a microcomputer for controlling the memory means, recording means, display means, driving information sensing means, storing means and the communication control means, computing a remaining insurance value or a used insurance value by computing the information on the insurance memorized in the memory means and the information inputted by the driving information sensing means, and subtracting or renewing the insurance value memorized in the memory means as much as the computed remaining insurance value or the used insurance value.
